(19) United States
(12) Patent Application Publication
(10) Pub. No.: US 2021/0342960 A1
(43) Pub. Date: Nov. 4, 2021

(54) System and Methods for Managing a Restaurant Experience

(71) Applicant: Ken Bridge, Houston, TX (US)

(72) Inventor: Ken Bridge, Houston, TX (US)

(21) Appl. No.: 17/230,422

(22) Filed: Apr. 14, 2021

Related U.S. Application Data
(60) Provisional application No. 63/019,415, filed on May 3, 2020.

(51) Int. Cl. G06Q 50/12; G06Q 30/02; G06Q 20/32

(52) U.S. Cl. CPC G06Q 50/12; G06Q 20/322; G06Q 30/0226

(57) ABSTRACT

Embodiments described herein comprise a restaurant management system comprising a restaurant, a restaurant customer module loaded on a customers electronic device, and a restaurant employee module loaded on an employee electronic device. The restaurant management system is configured for the customer to order one or more items on the customer electronic device from the restaurant and the employee may receive the one or more items on the restaurant employee module in order to prepare the one or more items.

### BACKGROUND

Embodiments of the inventive subject matter generally relate to data processing techniques for managing a customer's experience at a restaurant via a mobile app.

Existing restaurants have waiters and bartenders that are required to take customer orders. The customer orders are then entered into a point of sale computer or by the waiter. The point of sale computer will send the order to the appropriate station for example the kitchen or the bar. The station will then prepare the order. The waiter will pick it up and deliver it to the customer's table.

There is a need to allow a customer to manage their restaurant experience using an application on a mobile device. There is a further need to allow a restaurant to manage their workflow and interaction with a customer on any suitable device without the need for a point of sale computer.

The invention relates to a system and method for managing a restaurant experience with one or more electronic devices. More particularly, the invention relates to techniques for allowing a customer and restaurant to interact with their mobile interfaces.

### SUMMARY

Embodiments described herein comprise a restaurant management system comprising a restaurant, a restaurant customer module loaded on a customer's electronic device, and a restaurant employee module loaded on an employee electronic device. The restaurant management system is configured for the customer to order one or more items on the customer electronic device from the restaurant and the employee may receive the one or more items on the restaurant employee module in order to prepare the one or more items.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a restaurant system for managing a restaurant experience.

FIG. 2 depicts a restaurant management system.

FIG. 3A depicts electronic devices for operating the restaurant management system according to an embodiment.

FIG. 3B depicts electronic devices for operating a customer App and an employee App according to an embodiment.

FIG. 4 depicts a flow diagram for operating the restaurant management system according to an embodiment.

FIG. 5 depicts a flow diagram for operating the restaurant management system according to an embodiment.

### DESCRIPTION OF EMBODIMENT(S)

The description that follows includes exemplary apparatus, methods, techniques, and instruction sequences that embody techniques of the present inventive subject matter. However, it is understood that the described embodiments may be practiced without these specific details.

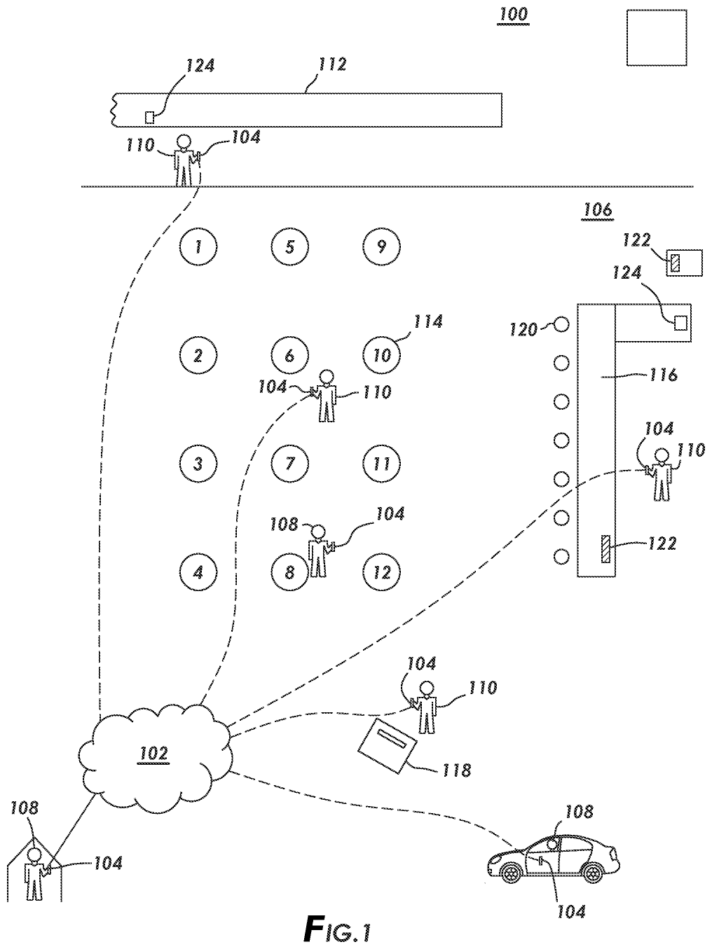

FIG. 1 is a flow diagram illustrating a restaurant system 100 for managing a restaurant experience. The restaurant system 100 as shown includes a restaurant management system 102, one or more customer electronic devices 104, one or more restaurant electronic devices 105, a restaurant 106, one or more customers 108, and one or more employees 110. The electronic devices 104 and 105 as shown are mobile devices, for example smart phones or tablets. Although shown as smart phones or tablets, it should be appreciated that the electronic devices maybe any suitable devices capable of running the restaurant management system 102 including, but not limited to, smart watches, a tablet computer, a laptop computer, a desktop computer, and the like. The restaurant 106 may be any suitable restaurant, bar, stadium, music venue, sporting event, outdoor event, and the like, for serving the customers 108 food, drinks, and other items. The restaurant 106 may include, but is not limited to, a kitchen 112, one or more tables 114, a bar 116, a host stand 118, retail sales, and one or more bar seats 120.

The restaurant management system 102 allows the customers 108 to manage and control their entire restaurant experience. In addition, it allows the employees 110 to interact with and get direction from the customers 108 during the customers' 108 restaurant experience. The restaurant management system 102 allows the customer 108 to select from multiple restaurants 106 in an area on their electronic device 104. With the specific restaurant 106 selected the customer 108 may then select the type of restaurant experience including, but not limited to, dine-in, take out, and/or delivery. The restaurant management system 102 allows the customer 108 to order items (such as food, drinks, services, and the like) on their electronic device 104. Upon the customer 108 ordering items, the employees 110 may interact with the customer 108 and/or begin preparing the items for the customer 108. The employees 110 may receive the orders from the customers 108 on the employees' 110 electronic devices. During the course of the restaurant experience, the customer 108 and employees 110 may interact on their electronic devices in order to ensure the customer 108 is getting the food, drinks and other items they need during the entire experience as will be discussed in more detail below.

The customer electronic device 104 and the employee electronic device 105 may include any suitable items to ensure the effective operation of the electronic devices 104 and 105 including, but not limited to a processor, memory, a graphics engine, a display controller to provide display capabilities, one or more communication modules to provide an interface to communication networks, such as Bluetooth®, 3G, 4G, 5G, WiFi®, WiMax®, and the like. The electronic device 104 and 105 platform may include a sensor hub 218 module to handle input from sensors such as a touch sensor, gyroscopic sensor, thermal sensor, GPS, etc. The electronic device 104 and 105 may include any suitable operating system (OS) to provide a software platform including, but not limited to a mobile OS such as iOS provided by APPLE, INC., Android™ provided by GOOGLE, INC., or an OS for another type of mobile device such as Windows® provided by MICROSOFT, INC., Mac® OS X® provided by APPLE, INC., or Linux® provided by Linux® distributors, and the like.

The restaurant 106 may include one or more point of sale computers 122 and printers 124. The point of sale computers 122 are systems that may operate a portion of the restaurants 106 business. The point of sale computers 122 are located in the restaurant 106 and do not move from their location in the restaurant 106. The restaurant management system 102 may operate independently of the point of sale computers 122 or may be integrated with them as will be discussed in more detail below. The restaurant management system 102 may be cloud and mobile based with no integration to existing POS systems in an embodiment. Further, the restaurant management system 102 may allow the restaurant 106 to exclude a point of sale system 122 and servers 204 from their restaurant 106.

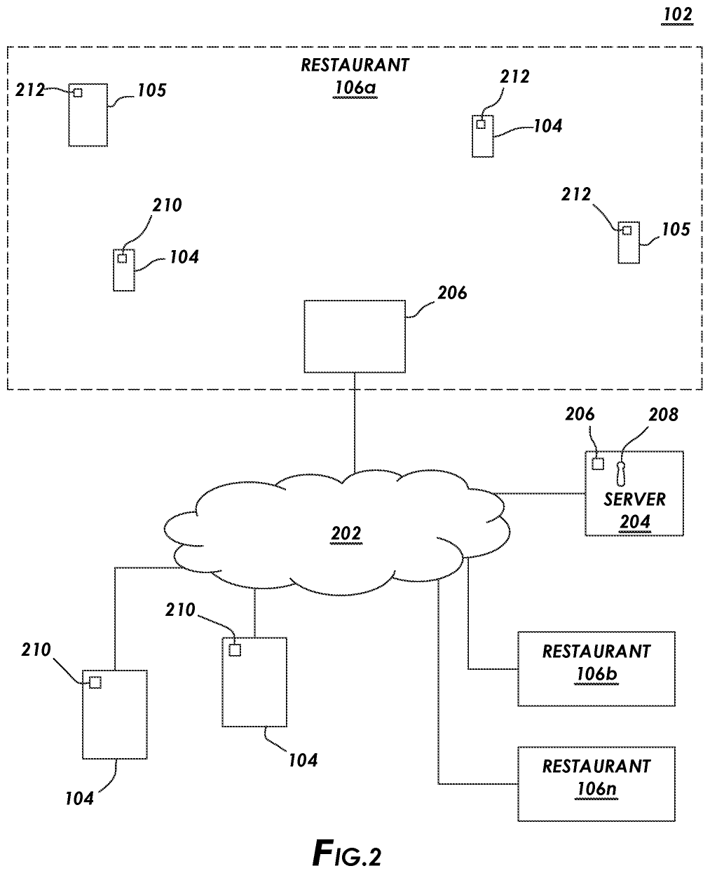

FIG. 2 depicts the restaurant management system 102 according to an embodiment of the invention. The restaurant management system 102 may include the one or more customer electronic devices 104a-n, the one or more operator electronic devices 105a-n, a communication network 202, one or more servers 204, and an optional wireless access point 206. The restaurant management system 102 may service any number of restaurants 106a-n.

The one or more server(s) 204 may be remote from the one or more electronic devices 104 and 105. The one or more servers 204 may be completely or partially cloud based. In addition, the servers 204 may be located at any suitable location, including in any of the restaurants 106a-n (although the system can run independently of servers in the restaurant 106). The server 204 may include a processor 206 and a memory 208. The server 204 can provide a platform as part of a cloud application service from which Apps can be downloaded. In some examples, the server 204 includes a client program 207, executable by the processor 206 of the server 204, to receive requests to download the executable code via the network 202 or cloud 238 to any of the electronic devices 104 and 105. The memory 208 may store executable code, including a restaurant customer module 210 and a restaurant employee module 212. The modules of apps include instructions performable by the electronic devices 104 and 105. In some examples, the modules 210 and 212 can be downloaded as an App to any of the electronic devices 104 and 105.

Other functionality not directly related to restaurant management may include power management, presentation of advertising, software or firmware updates, system quality or security checks, etc. Any of the restaurant management system's network components (e.g., the one or more electronic devices 104 and 105 and the point of sale computers 122) may include hardware and machine-readable media including instructions for performing the operations described herein.

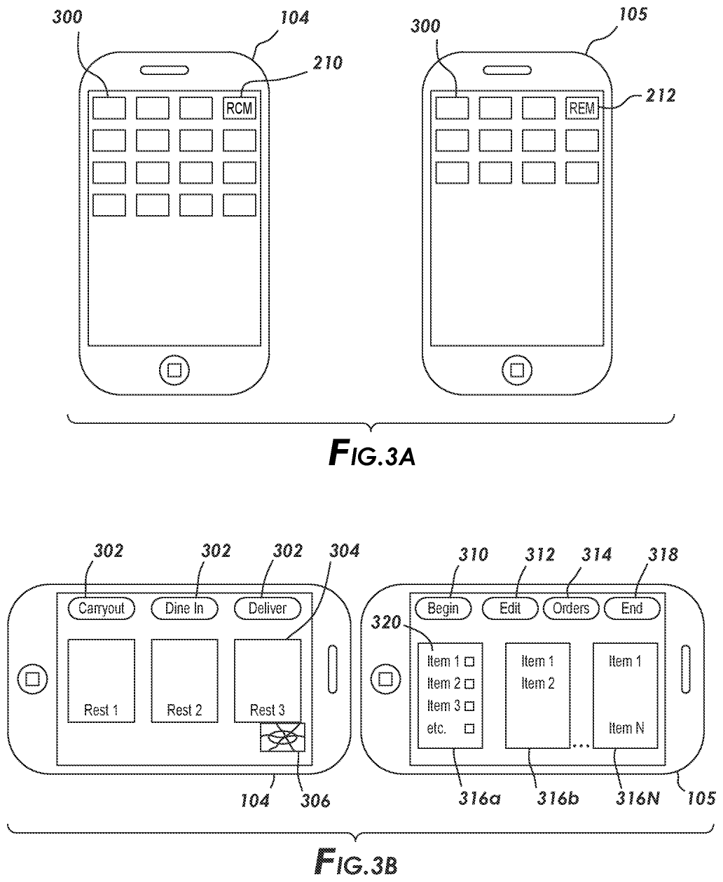

FIG. 3A depicts an example of the one or more electronic devices 104 and/or 105 having the restaurant customer module 210 (customer App) and a restaurant employee module 212 (restaurant App) respectively. Each of the electronic devices 104 and 105 may have any number of Apps 300, as shown. When the customer 108 selects the customer App 210 icon, the restaurant customer module 210 opens, as depicted in FIG. 3B. In some embodiments, the customer electronic device 104 may first present a menu, select preferences, and the like. In other embodiments, the electronic device 104 can first present a menu, preference selection menu, home screen, and the like, from which the customer 108 can navigate through content, select preferences, and the like. In some embodiments, the electronic device 104 will only present a menu, preference selection menu, home screen, etc. the first time the application associated with the content distribution engine is run (for example, to determine initial preferences, settings and the like).

In addition to the restaurant customer module 210 (customer App) and a restaurant employee module 212 (restaurant App) there may be a restaurant companion module (companion App). The companion App may be run by restaurant management and/or owners in order to more effectively manage the restaurant 106. The companion App may perform any of the features described herein for the restaurant employee module 212. The companion App may be used for certain features that the restaurant may not want all of the employees to have access to. The companion App may perform features including, but not limited to, adding/removing items from menu, changing pricing, giving special offers, running sales reports, running revenue reports, running customer reports and the like. The companion App, the customer App and the restaurant App may be an App on an electronic device, or may be web based software on any web based browser.

Although the Apps described herein are shown as being on an electronic device 104 and/or 105, it should be appreciated that any of the Apps described herein may be executed through an instant App or App Clips. The instant App allows the user to execute the Apps described herein, or a portion of the Apps without the need to download the entire App on the customer's or employee's electronic device. In one example, a customer 108 may scan a QR code or NFC sticker/tag (Near Field Communication) at a table, or other location associated with the venue. The scanning of the code, sticker and/or tag may then bring up the instant app and give the customer 108 the ability experience the entire restaurant experience(s) described herein, without the need to load the customer App 210.

When the employee 110 selects the restaurant App 212 icon, the restaurant employee module 212 opens, as depicted in FIG. 3B. In some embodiments, the customer electronic device 104 and the employee electronic device 105 may first present a menu, select preferences, etc. In other embodiments, the electronic device(s) 104 and 105 can first present a menu, preference selection menu, home screen, and the like from which the customer 108 or employee 110 can navigate through content, select preferences, and the like. In some embodiments, the electronic device(s) 104 and 105 will only present a menu, preference selection menu, home screen, etc. the first time the application associated with the content distribution engine is run (for example, to determine initial preferences).

FIG. 3B depicts presentation of examples of the customer App 210 and restaurant App 212 content received on the electronic devices 104 and 105 in one embodiment. As depicted in FIG. 3B, the electronic device 104 is presenting content received from the server 204 or any suitable content distribution engine, cloud and/or stored wholly or partially on the device. The customer electronic device 104 may display one or more experience preference options 302, one or more location preference options 304, and a location map 306 in an embodiment. The experience preference options 302 (or icons/buttons) may allow the user to select the type of experience at the restaurant 106. As shown, the options are dine in, carry out, and/or delivery. However, it should be appreciated that any number of experience preference options 302 may be selected by the customer including, but not limited to, waiter preference, type of food needed (for example vegetarian, all meat, low carb, gluten free, and the like), kid friendly, and the like. The one or more location preference options 304 may allow the customer 108 to select the restaurant 106, or types of restaurants 106a-n, they would like to experience. As shown, there are restaurants the customer 108 may select. The restaurants displayed may be selected based on any suitable criteria including, but not limited to, the location of customer, customer's past restaurant experiences, highly reviewed restaurants, value priced restaurants, nutrition, suggestive selling, friend alerts, contacts located at the restaurant, gift alerts, special alerts, reviews, waitlist, reservations, favorites, repeat orders, and the like.

In an embodiment, a customer 108 and or employee 110 may be able to store their likes and dislikes of items on the menu. For example, if a customer is eating at a restaurant 106, they may really enjoy an entre and a drink. The customer may then like the item(s) on the menu at that restaurant 106. This feature may allow the customer to remember the items tried and liked or disliked from their last experience. The employees 110 may do a this to the menu items as well in an effort to suggest to the customer's what their preferences are. The likes and dislikes from the customer's or employees may be shared on the App, any social media, the internet, the restaurant webpage and the like.

The location map 306 option may allow the customer to choose a location to search for their experience. Geo-fencing may be used to limit the number of restaurants 106 the customer 108 sees to ones located in their geographic location. In addition, Geo-fencing may be used to set a specific boundary for a restaurant's 106 specified delivery area. Although the one or more experience preference options 302, the one or more location preference options 304, and the location map 306 are shown as options on the customer App, it should be appreciated that any number of items and selections to improve the customer's 108 restaurant experience may be included in the restaurant customer module 210.

As depicted in FIG. 3B, the employee electronic device 105 is presenting content received from the server 204 or any suitable content distribution engine, cloud and/or stored wholly or partially on the device. The employee App 212 on the employee electronic device 105 may display content received from the server 204 or any suitable content distribution engine. The employee electronic device 105 may display a begin option 310, an edit options 312, an orders option 314, a tickets option 316 and an end option 318 in an embodiment. The begin option 310 may allow any number of employees 110 to begin a shift and/or task on their electronic devices 105. The edit option 312 may allow the employee(s) 110 to edit any number of items on the menu and/or customer experiences as will be described in more detail below. The orders icon 314 may allow the employee 110 to select the pending orders in an embodiment. The orders icon may pull up one or more tickets 316a-316n in an embodiment. In another embodiment, the one or more tickets 316a-316n may be displayed in any suitable manner including on the home screen of the App. Each of the one or more tickets 316a-n may represent a customer(s) 108 order (take-out, dine in, or delivery). Each of the one or more tickets 316a-n may display one or more items 320 on the ticket. The tickets, and/or on the ticket(s), may be displayed to all employees 110 or split up to suitable employees 110. For example, a customer's ticket may be split between the kitchen, the bar, and waiters. Depending on the items ordered. The ticket options or icons 316a-n may line up by priority. In an embodiment, the ticket icons 316a-n may line up by time ordered. Therefore, as the customers 108 order items, the ticket icons 316 may display on the employees 110 electronic devices 105 in chronological order. Although described as being displayed in chronological order, it should be appreciated that any suitable order to display the ticket icons 316 may be realized including, but not limited to, by cook times, by customer priority (for example an important customer, or one who has a time requirement), by distance from the restaurant and travel time, and the like.

The employee App 212 may also include a search feature. The search feature may allow the employee 110 to search the restaurant by table, by section in the restaurant, by sections or grids in a stadium or venue, by pod, by check/tab, and the like.

Further, the ticket icons 316 may display in varying formats depending on urgency. For example, a ticket may display in an emergency color such as red or yellow if it is an old ticket that has not been made, while a new ticket may be displayed in green to indicate less urgency. Although described as using red, yellow and green, it should be appreciated that any method for alerting the employees 110 may be used including, but not limited to colors, flashing items, sound and the like. The ticket order may be influenced by customer's 108 notes about deferring orders till later, or arrival times using predictive arrival technology, and the like.

As the items are made and/or delivered by the employees, the employee 110 may remove, or indicate, the item icon 320 on the ticket icon 316a-n. The employee 110 may check off or remove the item icon 320 using any suitable method including, but not limited to by touching the item on the screen, voice activation, and the like. As the items icon 320 are selected and or delivered, the order on the ticket icon 316 is being completed. Upon making or delivering all of the items represented by the item icons 320 on the ticket icon 316 to the customer 108, the employee 110 may close or sell the ticket and thereby remove the ticket icon 316 from their display. Each of the ticket icons 316 and/or item icons 320 may be displayed with any suitable information including, but not limited to, order number, arrival time, items ordered, messages, completion, completion time and the like. At the end of a shift for an employee 110 they may select the end icon 318. The end icon 318 may allow the employee 110 to stop receiving orders and close out their shift or a portion of their shift.

Although the item icons 320 and tickets 316 are described as being removed by the employee (s) 110 as they are sold or delivered to the customer 108, it should be appreciated that the item icons 320 and tickets 316 may be removed as delivered to customer 108 automatically. For example, in an embodiment, scanner and/or camera and the like may be located at or near the location of the customer in the restaurant or venue. As items are delivered to the customer 108, the customer App 212 may scan the items and remove the associated item icons 320 and or tickets from the display. Although described as being scanned at the customer's 108 location it should be appreciated that the items may be scanned upon being made or upon delivery, or at any other time during the experience. Although the items are described as being removed by scanning or recording them, it should be appreciated that any suitable method for removing the items from the tickets may be realized including, but not limited to the fulfilled tickets may auto “sell” or “complete” by using location services and GPS technology.

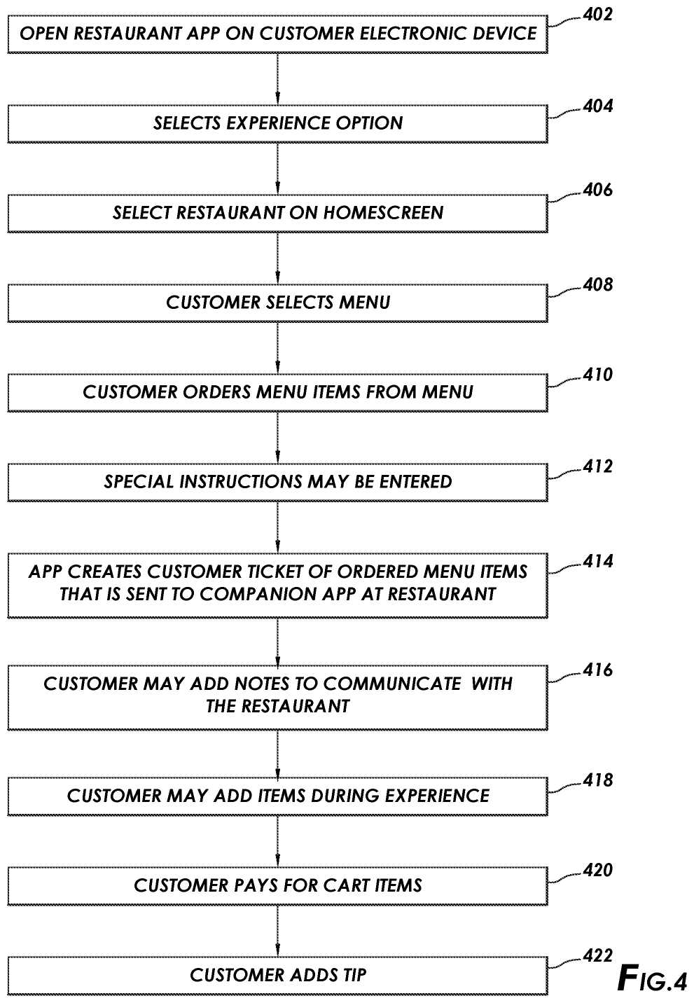

FIG. 4 depicts a flow diagram 400 for operating the restaurant customer module 210 (customer App) of the restaurant management system 102 according to an embodiment. The flow chart begins at block 402 where the customer 108 selects to open the App on their electronic device 104. The App will then open allowing the customer 108 use the features of the customer App to manage their restaurant experience. The flow continues at block 404 wherein the customer selects an experience from the experience preference options 302. The customer 108 may select carry out, dine in, delivery, and/or any other suitable option, including, but not limited to a combination of experiences. The flow then continues at block 406 wherein the customer 108 selects a restaurant from the location preference options 304. The customer 108 may choose the restaurant from any number of criteria, as described above. The restaurants displayed to the customer may be arranged in any suitable order depending on the customer's 108 preferences, likes, dislikes, favorites and the like. The flow continues at block 408 wherein the customer 108 may select a menu. Each restaurant may customize their menu for display to the customer 108. The menu may be one menu or multiple menus. For example, a restaurant may have any combination of appetizer, entrees, drink, wine, beer, alcohol, an experience menu, specific customer likes, display the last items the customer had at the restaurant, or any combination thereof. With the menu selected, the flow continues at block 410 wherein the customer 108 may select one or more items from the menu(s). The customer 108 may choose any number of items that they would like delivered to their location in the restaurant, or to be picked up for carry out or to be delivered to a location. The once the items and quantities are selected the customer(s) 108 may select or enter the items to send to the restaurant or restaurant App. The flow continues at block 410 wherein the customer(s) 108 may enter special instructions for the restaurant 106. Special instructions may include any suitable instructions relating to the items selected. For example, the instructions may include, but are not limited to, modifying menu items, adding items to a dish, requesting modifications to a drink and the like. Any suitable employee 110 in the restaurant 106 may respond to the special request. If the request requires an up charge or more money for the modification, the employee 110 may send an amount to the customer 108 on the customer App. The customer 108 may then accept or deny the price change to the item(s). If the customer 108 accepts the extra charge, the extra amount will be added to the price of the item(s). If the customer 108 denies the extra charge, the item will be prepared without the modification.

The customer App 210 and Restaurant App 212 may further include a messenger app. The messenger App may allow the customer 108 or an employee 110 to message any customer directly either while enjoying their experience or after their experience. In the messenger App a customer 108 and/or employee 110 may be able to allow or block communications between them.

The flow continues at block 414 wherein the restaurant management system 102 creates a customer ticket of the selected or ordered items. The ticket may be sent to any number of the employees 110 on their respective employee electronic devices 105 at the restaurant 106. For example, the alcoholic drinks on the ticket may be sent to the bar, the non-alcoholic drinks may be sent to a waiter and the food items may be sent to a kitchen employee or expediter. Upon receipt of each of the ticket, the employee(s) 110 may automatically send a note or acknowledgement of receipt to the customer 108. In addition, the employee 110 may send a customized note to the customer 108 in order personalize the experience. The employees 110 may then prepare, make, and deliver the customer(s) 108 items to the customer 108 as will be discussed in more detail below. The flow chart continues at block 416 wherein the customer(s) 108 may add notes to the ticket as items are being prepared/delivered. The customer(s) 108 may add any suitable notes to enhance their experience at the restaurant 106 including, but not limited to, notes about arrival times of items (e.g. one item before another), notes about moving locations in the restaurant/bar or for delivery, notes about refills of drinks, server preference, and the like.

The flow chart continues at block 418 wherein the customer(s) 108 may add items to the ticket(s) during the experience. The customer(s) 108 may add any suitable number of items including, but not limited to, drink refills, extra alcoholic drink, deserts, extra food, to go items, and the like.

The flow chart continues at block 420 wherein the customer pays for the items selected at the restaurant 106. Although shown toward the end of the flow chart, it should be appreciated that the customer may pay at any suitable time during the experience. For example, the items may be paid for at the end of the experience, upon ordering of the items, and the like. The customer 108 may also open a tab and pay when they are ready. The items may be automatically paid for by a payment method set up on the customer restaurant module 210 including, but not limited to credit card, bank pay, PayPal, Venmo, crypto currency, an App coin which may be a utility token built on ERC-20 block chain network specifically for the customers 108 herein, and the like. Customers 108 may accumulate the App coin(s) with every purchase, and then redeem them, gift, save or trade them for other suitable payment methods on customer exchanges. The App coin(s) may serve as a loyalty and/or rewards program that may be tracked on the customer App 210 and/or the employee App 212. The restaurant management system 102 may act as a payment facilitator. In an embodiment, the App coin(s) are Roovy Coin (RVY). The Roovy Coin may serve as a loyalty and rewards program for users and/or customers. The users/customers may earn RVY through the Roovy platform (restaurant management system) purchases and may also purchase RVC in advance to spend, redeem, store, trade etc. RVY is built on the ERC-20 (Ethereum) blockchain and will be traded on multiple exchanges.

The flow chart continues at block 422 wherein the customer(s) 108 may tip the employees 110. The customer(s) 108 may tip an amount to be distributed to the restaurant or customize their tip. In a custom tip, the customer 108 may wish to tip a certain employee more than others for example the bar, waiter, kitchen, and the like. Further, the customer(s) 108 may add notes to the tip, or ticket to express appreciation, or disapproval, or tips for improvement, with the restaurant. The customer may then leave the restaurant and end that particular restaurant experience.

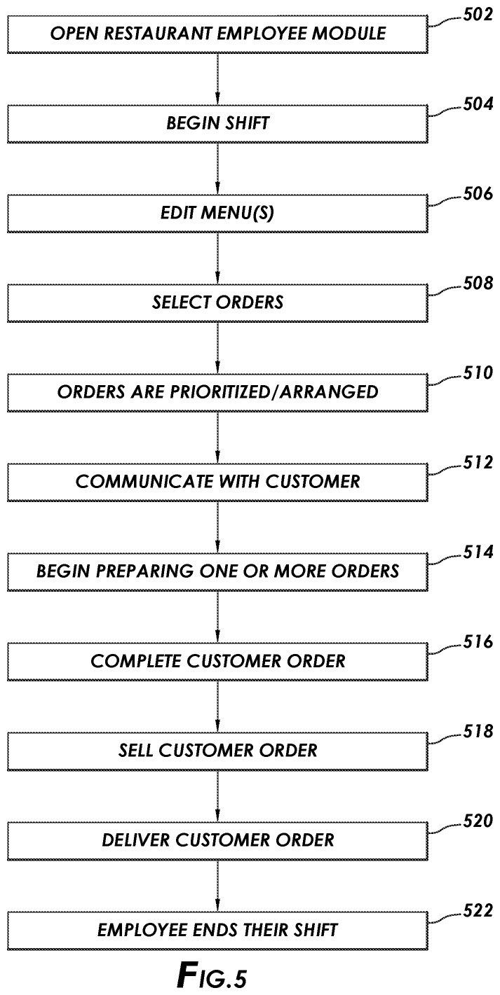

FIG. 5 depicts a flow diagram 500 for operating the restaurant employee module 212 (employee App or restaurant facing App) of the restaurant management system 102 according to an embodiment. The flow chart begins at block 502 wherein an employee 110 may open the restaurant employee module 212 on their electronic device(s) 105. The electronic device 105 may be any suitable electronic device describe herein. The electronic device 105 may be a device owned by the restaurant 106 or may be the employee's personal electronic device (for example, mobile phone, tablet, and the like). The flow continues at block 504 wherein the employee 110 may choose to begin. The begin icon/button may allow the employee to begin a restaurant shift in an embodiment. Although described as beginning a restaurant shift, it should be appreciated that the begin icon may allow the employee 110 to begin any restaurant activity including, but not limited to, begin managing orders, begin delegating work, and the like. The employee App 212 may keep track of employee time for payroll by tracking the begin time and end time using the App 212.

The flow chart continues at block 506 wherein the employee 110 may edit any one or more of the menus via the restaurant employee module 212 and/or the companion App. When the employee 110 edits the menu, the customer 108 may see the change to the menu immediately. For example, if the restaurant 106 runs out of an item, any one of the employees 110 may delete that item from the menu. The item that was deleted may immediately be eliminated from the customers' 110 menu display in an embodiment. In another embodiment, any one of the employees 110 may add a new item to the menu. For example, the employee 110 may add an entrée, drink, and/or dessert to the menu(s). The added items may be immediately displayed on the customer's 108 electronic device 104 for them to select. This feature allows the restaurant to add specials and special offers to customers on a real time basis and change the menu(s) without the need for printing more menus or writing items on special boards. In addition to adding or deleting items from the menu, the employees may edit descriptions, pricing, and/or photos/displays of menu items in real time. To edit the image of an item, the employee 110 may select from existing photos, search and copy from the internet, or take a new photo with their camera. The edit menu block 506 allows the restaurant to continuously manage their content that is displayed to the customers 108.

The flow chart continues at block 508 wherein the employee(s) 110 may select orders. The employee 110 may select pending orders, partially pending orders, closed orders and the like. Upon selecting pending orders, the flow chart continues at block 510 wherein the orders or tickets (ticket icons 316) are prioritized and/or arranged. The tickets, or ticket icons 316, may be arranged in any suitable arrangement including those described herein. The ticket icons 316 may be displayed in linear format, or any other suitable arrangement.

The flow chart may optionally continue at block 512 wherein the employee 110 may communicate with the customer 108. The communication may be any suitable communication to the customer 108, for example upon selecting a ticket icon 316, an automatic communication may be sent to the customer 108 indicating the order was received and/or is being prepared. Further, the employee 110 may customize the message and communicate with the customer 108 throughout the experience. The messages may be auto generated or customized depending on the customer 108, the restaurant 106 and/or employee's 110 preferences. The communication feature may allow the restaurant to upsell items, down sell items, confirm age of customer (for example if buying alcohol), and the like. It should be appreciated that the restaurant 106 and/or employees 110 may communicate with the customer(s) 108 via the app at any time during the restaurant experience. The customer 108 may be able to communicate with the restaurant management and/or any employee 110 as described herein.

The flow chart continues at block 514 wherein any of the employees 110 may begin preparing the one or more items on any number of the tickets (and/or ticket icons 316). As described above, the ticket icons 316 may be prioritized by any suitable method. Further, the items, or item icons 320, may be prioritized by any suitable method to enhance the customer's 108 experience. As the items are prepared and completed the items may be removed from the ticket or ticket icon via any suitable method including those described herein. The items may be prepared until all of the items on the ticket and/or ticket icon 316 are complete as shown in block 516.

The flow chart continues at block 518 wherein the items are sold to the customer 108. When the items are sold to the customer, the customer 108 may be charged for the items. The charge may include any taxes and or tip that the customer 108 would like to add, or the restaurant 106 would like to automatically add. The sell may occur at any suitable time during the restaurant experience, including but not limited to, when the items are ordered, when the items are delivered, upon the customer completing their restaurant experience and the like.

The flow chart continues at block 520 wherein the order is delivered to the customer 108. The orders, which may be made up of all, or a portion of the items on the ticket icon 316 may be delivered to the customer 108 together, or as appropriate by any of the employees 110. For example, the drinks may be delivered by the bartender or waiter continuously while the customer 108 waits for the food to be prepared and delivered by the waiter and/or kitchen, runner, busser and the like. Once the items are delivered, any of the employees 110 and/or customers 108 may communicate using the App as described herein. Upon delivering and or selling the ticket to the customer 108, the entire ticket may be closed and/or removed from the employees' 110 display.

As an alternative to delivering items to the customer 108, the employees may elect to page the customer(s) 108 in order for the customer to pick an item up at a location in the restaurant 106 such as a counter, bar, kiosk and the like.

The employee 110 may repeat any of these steps throughout a work shift to ensure that each of the customers' 108 experience is a good one. The flow chart continues at block 518 wherein the employee 110 may end a shift. The shift may end for the employee by hitting the end icon 318. The end of their shift may transfer their open tickets to other suitable employees 110. The end of the shift may be tracked in a payroll system.

Although described as running the restaurant management system 102 entirely on the employees 110 electronic devices, it should be appreciated that all or a portion of the system may tie into an existing point of sale system 122. For example, the system may print the tickets on a printer in addition to displaying them on the employees 110 electronic device. The restaurant management system 102 may integrate with the point of sale system 122 for example through Wi-Fi. In addition the restaurant management system may connect to other hardware for example the printers 124 via Wi-Fi or any other suitable method.

The location or GPS system in the customers' 108 electronic device may be used to enhance their experience. For example, the location device may track the customer's location in a restaurant/bar/casino/club/sports arena/music venue and the lie in order to ensure that the customer's items are delivered to them no matter where they go in the restaurant or establishment. In addition, the location tracking may be used to coordinate cook times with arrival times for to go orders. For example, if an item or ticket takes 5 minutes to prepare and the customer orders, the ticket at a location 30 minutes away, the App may hold the ticket until the customer 108 is the appropriate distance away (5 minutes in this example) and then prepare the items on the ticket. This predictive arrival technology allows the restaurant 106 to have fresh prepared items upon the customers arrival. The predictive arrival technology may further track customer habits, such as time from parking lot to table, if the customer valleys their car, walk time from the car to the restaurant and the like in order to get a better arrival time for the customer 108. In addition the predictive arrival technology may be used for placing customers on the waiting list of the restaurant 106. For example, if the customer is 30 minutes away and they request to be put on the wait list, the App may move them up and down the wait list with the customers' 108 arrival time in mind in order to eliminate or minimize their wait.

The restaurant management system 102 may further allow the restaurant to customize items or tickets for each customer 108. For example, if a customer 108 has items they specially modify or always order, the system may allow those customer specific items to be displayed to the particular customer, or a group of customers. In addition, for items that a customer orders a favorites button or icon may be added to the customer App to allow the customer to easily order favorites at each restaurant 106a-n in the restaurant management system.

The restaurant management system 102 may further allow the customers 108 to network or share their restaurant experience with other customers and restaurants. For example, the customer 108 may be able to share their location with friends who have the customer app. The customers 108 may also share other features of their experience with other users including, but not limited to, their favorite dishes, their order, a review of their experience, likes and dislikes of items, estimated arrival time, and the like.

In addition, the restaurant management system 102 may allow a customer to add their names to a wait list while they are traveling to the restaurant. The location track may assist with coordinating arrival times with wait times to more efficiently manage the line or wait at the restaurant 106. The restaurant management system 102 may allow the customer to put their name on a wait list and time the customer's progress toward the restaurant in order to manipulate the wait list to seat the customer upon arriving at the restaurant.

In an embodiment, a shared delivery feature may be added to the restaurant customer module 210 and/or the restaurant employee module 212. The shared delivery feature may allow a customer 108 to select the option to deliver food to another customer 108. The customer 108 may select the shared delivery option for compensation such as, but not limited to, money, discounts on their items from the restaurant, credits at the restaurant, cryptocurrency and the like. In one example of the shared delivery option a customer 108 picking up their to go/carry out order from a restaurant may push the shared delivery option on their restaurant customer module 210. The restaurant customer module 210 may then alert the restaurant and/or the restaurant employee module 212 that the customer coming to the restaurant is willing to deliver other carry out orders to other customers 108. The GPS system in the customer's electronic device 104 may allow the restaurant employee module 212 to determine if there are deliveries on or near the customer's 108 route. If there are deliveries to be made, the restaurant management system 102 may then alert the customer 108 of the number of deliveries and the location from their route. The customer 108 may then select the deliveries that they agree to take on their restaurant customer module 210. The customer 108 upon picking up their food may also pick up the deliveries they will take to other customers 108. It should be appreciated that customers 108 at the restaurant 106 may also select this option before leaving the restaurant 106. In addition, any person in the vicinity of the restaurant may opt to deliver food for the restaurant.

In regard to the communication between the restaurant 106, the employees 110 and the customers 108, the restaurant management system 102 may further employ chat bots, and/or artificial intelligence to communicate with the customers 108. This method may be employed to communicate any number of items between the customer and the restaurants 106 including, but not limited to, frequently asked questions, nutritional information, menu items descriptions based on the customers spending and eating habits and the like. Further, the system may be used to suggest items or restaurants based on the customers' 108 preferences and patterns.

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A restaurant management system comprising:
a restaurant;
a restaurant customer module loaded on a customer's electronic device;
a restaurant employee module loaded on an employee electronic device; and
wherein the restaurant management system is configured for the customer to order one or more items on the customer electronic device from the restaurant and the employee may receive the one or more items on the restaurant employee module in order to prepare the one or more items of the customer.

2. The restaurant management system of claim 1, wherein the customer electronic device is a smart phone.

3. The restaurant management system of claim 2, wherein the employee electronic device is a tablet.

4. The restaurant management system of claim 1, wherein the restaurant management system does not connect to an existing restaurant point of sale system.

5. The restaurant management system of claim 1, wherein the restaurant management system is configured to allow the customer to send special instructions to the restaurant employees during the preparation of the one or more items.

6. The restaurant management system of claim 5, wherein the restaurant management system is configured to allow the employee to respond to the customer's special instructions as items are prepared.

7. The restaurant management system of claim 1, wherein the restaurant management system is configured to allow the employee to change the menu at the restaurant in real time on each customer's customer module.

8. A method comprising:
opening a customer app on an electronic device;
selecting an experience option for the venue by a customer;
selecting one or more items from a menu at the venue;
automatically creating a ticket at the venue in order for the venue to make the one or more items;
making the one or more items for the customer; and
delivering the one or more items to the customer.

9. The method of claim 8, wherein the venue is a stadium.

10. The method of claim 9, further comprising locating the customer in the venue and delivering the items to the customer.

11. The method of claim 8, further comprising editing the menu of the venue as items on the menu change and sending the menu changes to the customer as the items are edited.

12. The method of claim 10, further comprising adding a note by the customer to communicate changes to menu items.

13. The method of claim 12, further comprising the venue responding to the customer note on an employee app in order to confirm the change.

14. The method of claim 8, wherein the venue is configured to use the customer app and an employee app in the absence of a venue point of sale computer system.

15. The method of claim 8, wherein the selecting of the experience option further comprises ordering the one or more items for pick up.

16. The method of claim 15, further comprising automatically determining the distance of the customer from the venue and beginning preparation of the items based on the travel time to the venue.

17. The method of claim 16, further comprising storing an App coin as a customer loyalty program.

18. The method of claim 17, further comprising allowing a customer to increase their App coin through purchases at the venue.

19. The method of claim 18, further comprising allowing a customer to send the App coin with one or more other customers.

20. The method of claim 18, further comprising allowing a customer to pay for their one or more items using the App coin.
